(19) United States
(12) Patent Application Publication
(10) Pub. No.: US 2026/0086790 A1
(43) Pub. Date: Mar. 26, 2026

(54) AUTO UPGRADE OF CLOUD SERVICE CUSTOMIZATIONS

(71) Applicant: Oracle International Corporation, Redwood City, CA (US)

(72) Inventors: Ben John Jacob, Kottayam (IN); Aswin Anand, Cochin (IN); Sameeha Saithathul Fathima, Trivandrum (IN)

(21) Appl. No.: 18/892,895

(22) Filed: Sep. 23, 2024

(51) Int. Cl. G06F 8/65

(52) U.S. Cl. CPC G06F 8/65

(57) ABSTRACT

Various embodiments of the present technology generally relate to systems and methods for providing auto-upgrade functionality for cloud service customizations, a customization being custom programming code designed to alter functionality of a software product. In certain embodiments, a method may comprise retrieving an existing customization written in a first version of a programming language, evaluating the existing customization using a first analyzer to identify compatibility errors between the existing customization and a selected version of the programming language supported by the software product, evaluating the existing customization using a second analyzer configured to identify elements of the existing customization that violate proprietary constraints on the selected version of the programming language imposed by the software product, generating a large-language model (LLM) prompt based on the analyzer outputs and the existing customization, and writing an updated customization compatible with the selected version of the programming language based on the LLM prompt.

### TECHNICAL FIELD

Various embodiments of the present technology generally relate to the improvement in functionality for cloud service customizations. More specifically, embodiments of the present technology relate to systems and methods for providing automatic upgrade functionality for customizations of cloud service applications.

### BACKGROUND

In software application environments, including software as a service (SaaS) and cloud-based application deployments, users (such as SaaS customers or clients, and their associated system administrators or “admins”) may be provided with various default or “out-of-the-box” functionality. For example, a business-to-consumer (B2C) cloud service application, such as Oracle B2C Service Cloud, may provide a customer service platform to its clients, allowing a client to handle and track service requests, customer calls, and other customer-facing interactions. In addition to the default functionality, some software application environments may allow clients to integrate their own customized features into the application product, in order to tailor the product to the specific needs and requirements of client organizations across industries. Customizations may be implemented as custom executable programming code or functions that integrate with or expand or alter the functionality of the base software application environment. In the case of a SaaS platform, the customizations may be uploaded and stored to the application cloud environment and executed along with the SaaS application for the client.

An example category of customizations may include custom process models (CPMs), which may allow associating PHP script with object events. Business logic can be migrated to PHP code, so effectively, business rules can be performed on Custom Objects. The custom processes may be predefined object event handlers (PHP scripts) that run as the result of an event occurring on standard or custom objects in a given cloud service. Object event handlers can also help an organization automate tasks based on the events that trigger them. Another category of customization may include browser UI (user interface) extensions, allowing users to create custom content to display on the software platform's browser UI by using an extensibility framework (e.g., using JavaScript). Similarly, users may implement customer portal customizations to create custom widgets by extending the functionality of a standard widget, or creating custom widgets from scratch using, e.g., PHP code. Other customizations, such as report customizations for data generated by reports, or script customizations for performing any extension on the product and connecting to external products, are also possible.

Software applications may be configured to recognize or integrate with customizations written in one or more recognized programming languages or standards. The customizations may be written as extensions to the underlying programming languages that power the cloud service application. As programming languages evolve and new versions are released, developers often face the challenge of updating existing codebases to comply with the latest standards and best practices. Software and programming language updates may result in changes that can cause code written for an older version to not function correctly, or to not run at all. Customers must ensure that their customizations remain compatible and functional with the upgraded software version. However, upgrading a cloud service application can potentially disrupt existing customizations, prompting customers to opt for maintaining older versions (when allowed) to avoid the complexities and efforts associated with upgrades. Software service providers may also stop offering support for older versions, and customers staying with older versions may not get access to newer features or improvements. Software application customers must therefore constantly balance the effort and complexity of upgrading their customizations to conform with current standards, or foregoing software upgrades and the benefits they provide. Accordingly, there exists a need for improved systems and methods for upgrading customizations for cloud service applications.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing an application optimization framework. In an embodiment, a customization upgrade system may comprise one or more processors, and a memory having stored thereon instructions that, upon execution by the one or more processors, cause the one or more processors to implement a software customization upgrade process to automatically rewrite an existing customization to meet selected programming language requirements, a customization being custom programming code designed to alter a functionality of a software product. The customization upgrade system may retrieve an existing customization written in a first version of a programming language supported by the software product, evaluate the existing customization using a first analyzer to identify compatibility errors between the existing customization and a selected version of the programming language supported by the software product, generate a large-language model (LLM) prompt based on the compatibility errors and the existing customization, and write an updated customization compatible with the selected version of the programming language using an LLM based on the LLM prompt.

In some embodiments of the customization upgrade system, the first analyzer may be a programming language semantic analyzer configured to recognize programming code not supported by the selected version of the programming language, and the first analyzer generates a semantic analyzer output identifying the compatibility errors based on the programming code not supported by the selected version of the programming language identified in the existing customization. The customization upgrade system may evaluate the existing customization using a second analyzer comprising a service constraint analyzer configured to identify elements of the existing customization that violate proprietary constraints on the selected version of the programming language imposed by the software product, and generate constraint analyzer output identifying the elements of the existing customization that violate the proprietary constraints. The customization upgrade system may generate the LLM prompt based on the semantic analyzer output, the constraint analyzer output, and the existing customization. In some examples, the customization upgrade system may evaluate the updated customization for compatibility with the selected version of the programming language supported by the software product. The customization upgrade system may evaluate the updated customization for compatibility via the programming language semantic analyzer, and output a second semantic analyzer output based on evaluating the updated customization. The customization upgrade system may further evaluate the updated customization for compatibility via the service constraint analyzer, and output a second constraint analyzer output based on evaluating the updated customization. In some embodiments, the customization upgrade system may determine whether the second semantic analyzer output or the second constraint analyzer output indicate an error with the updated customization, and when the error with the updated customization is indicated, generate a second LLM prompt based on the second semantic analyzer output, the second constraint analyzer output, and the updated customization, and rewrite the updated customization using the LLM based on the second LLM prompt. The customization upgrade system may, when the error with the updated customization is not indicated, apply the updated customization to the software product. In some examples, the software product may be a cloud service application, the first version of the programming language may be a previous version supported by an earlier version of the software product, and the software customization upgrade process converts the existing customization into the updated customization written in a latest version of the programming language supported by a current version of the software product, the updated customization having the same functionality as the existing customization.

In an alternative embodiment, a method may comprise operating a customization upgrade system to implement a software customization upgrade process to automatically rewrite an existing customization to meet selected programming language requirements, a customization being custom programming code designed to alter a functionality of a software product. The software customization upgrade process may include retrieving an existing customization written in a first version of a programming language supported by the software product, evaluating the existing customization using a first analyzer to identify compatibility errors between the existing customization and a selected version of the programming language supported by the software product, generating a large-language model (LLM) prompt based on the compatibility errors and the existing customization, and writing an updated customization compatible with the selected version of the programming language using an LLM based on the LLM prompt.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of an example system configured to implement auto-upgrade of cloud storage customizations, in accordance with certain embodiments of the present disclosure;

FIG. 2 is a flow diagram of an example system for implementing auto-upgrade of cloud storage customizations, in accordance with certain embodiments of the present disclosure;

FIGS. 3A and 3B are diagrams of a user interface for a system configured to implement auto-upgrade of cloud storage customizations, in accordance with certain embodiments of the present disclosure;

FIG. 4 is a flowchart of a method for auto-upgrade of cloud storage customizations, in accordance with certain embodiments of the present disclosure; and

FIG. 5 is a diagram of a system configured to implement auto-upgrade of cloud storage customizations, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

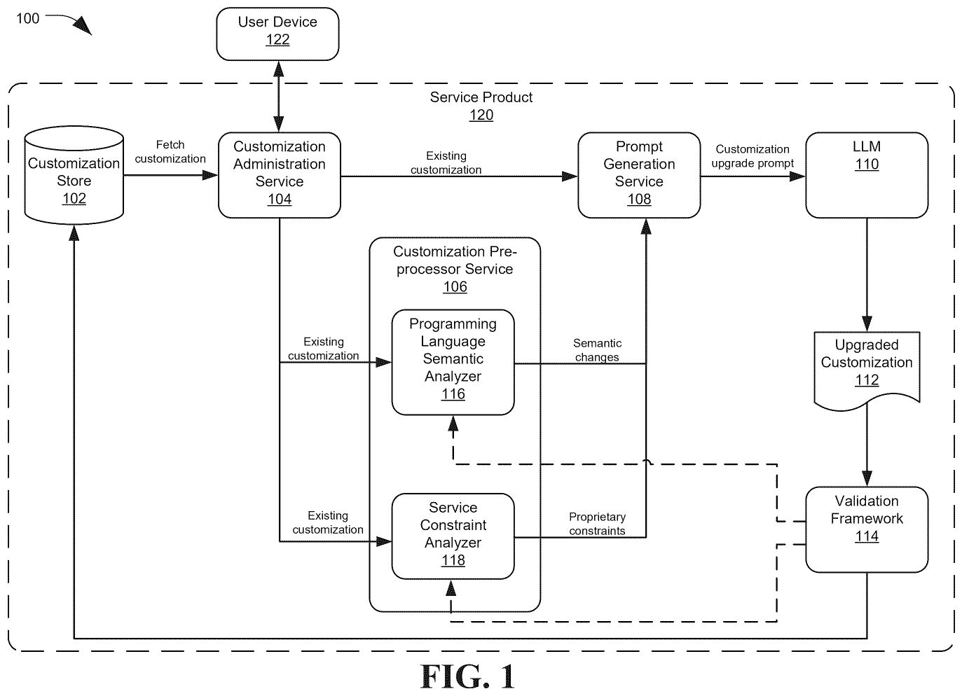

FIG. 1 is a diagram of a system 100 configured to implement auto-upgrade of cloud storage customizations, in accordance with certain embodiments of the present disclosure. The example system 100 may include a cloud service environment, such as a software as a service (SaaS) or platform as a service (PaaS) model deployed in a cloud environment, in which an application may be provided to customers (e.g., individual users, organizations, or other user groups). Each customer may have its own instance of the application, and may have different or individualized configuration settings applied for the application. Further, each customer may have its own customizations for the application, extending the application functionality or adding custom features, appearance, or other customizations.

As noted above, when a service product or application is updated, or the programming language versions supported by the application are updated, existing customizations may encounter errors or cease functioning. Customers may need to update the customizations to meet with the requirements of the service product, the programming language, or both. Manually updating customizations may be complicated and time-consuming, and may include identifying all changed in the programming language and service product requirements that are applicable to a customization, locating all the relevant outdated elements within the customization, and changing the outdated elements to meet with the latest requirements.

Rather than manually updating customizations, proposed herein are methods and systems to apply an artificial intelligence (AI) system utilizing a large language model (LLM) to detect outdated elements within a customization, and update those elements to meet with all software application and programming language requirements. At the heart of LLM technology lies the ability to understand and generate human-like text at scale. Unlike traditional natural language processing (NLP) models, which relied on predefined rules and patterns, LLMs can leverage deep learning techniques to analyze vast amounts of text data and learn the underlying structure and semantics of language. This capability of LLMs to learn languages may be applied to programming languages in addition to spoken or written “natural language” as used in normal human communications. LLM models, trained on massive datasets containing billions of words, can generate complex text in response to prompts, and can even generate programming language code.

LLM prompts can serve as input to the LLM models, guiding them to produce contextually relevant and coherent responses. Prompts may be provided by users directly, or generated by computing programs or modules configured to output queries designed to produce a specific type of response from the LLM. These prompts can vary in complexity and specificity, ranging from simple queries to detailed instructions or descriptions. Well-formed prompts that clearly communicate a desired output from the LLM model can steer LLMs towards generating desired responses. Prompts can include questions, commands, keywords, or contextual information that provide LLMs with the necessary context and constraints to generate meaningful text. Utilizing appropriate prompts, LLMs may be used for automating code rewriting tasks, enabling developers to efficiently update code from lower versions of a programming language to higher versions, as well as to comply with specific constraints of a cloud service product.

LLMs may be trained on vast amounts of text data, including code repositories, documentation, and online forums. Through deep learning techniques, LLMs may develop a comprehensive understanding of the semantics and syntax of programming languages. This semantic understanding can enable LLMs to accurately interpret the intent behind code snippets and generate syntactically correct equivalents in a higher version of the programming language.

Mathematically, LLMs can be used to capture complex language patterns and relationships within code. By analyzing patterns in code syntax, semantics, and structure, LLMs can identify common idioms, conventions, and best practices in programming languages. This can allow LLMs to produce code rewrites that adhere to the coding standards and conventions of the target language, resulting in more readable, maintainable, and efficient code.

Code rewriting tasks can involve handling variable complexity, including conditionals, loops, data structures, and algorithmic optimizations. LLMs may be equipped to handle this variable complexity through their ability to learn from diverse examples and adapt to different coding styles and paradigms. This mathematical flexibility can enable LLMs to generate code rewrites that preserve the functionality and performance of the original code while leveraging the features and improvements introduced in the higher version of the programming language.

Programming language upgrades, as well as cloud service application updates, often introduce version-specific changes, such as new syntax, APIs, language constructs, and deprecations. LLMs can effectively navigate these version-specific changes by learning from annotated datasets that highlight differences between language or application versions. By incorporating this knowledge into the code rewriting process, LLMs can automatically refactor code to comply with the latest language specifications, reducing manual effort and potential errors. By harnessing the power of deep learning and probabilistic modelling, LLMs can analyse and understand code snippets written in different programming languages, allowing for automated code rewriting and migration from lower to higher versions of a programming language.

LLMs may utilize the principle of probabilistic modelling, where the model learns the statistical properties of natural language or code from large datasets. By analyzing the frequency and co-occurrence of words, tokens, and syntax patterns, LLMs can infer the semantic meaning and context of code snippets written in different programming languages. This probabilistic modelling enables LLMs to understand the structure, logic, and intent behind code, making them suitable for code rewriting tasks.

LLMs may employ sequence-to-sequence learning techniques to translate code snippets from one programming language version to another. In this approach, the LLM may take a sequence of tokens representing the input code in the lower version of the programming language and generate a sequence of tokens representing the equivalent code in the higher version. By learning the mapping between input and output sequences, LLMs can effectively rewrite code while preserving its functionality and semantics.

Attention mechanisms may play a crucial role in LLMs by allowing the model to focus on relevant parts of the input code during the rewriting process. By attending to specific tokens or syntax elements, LLMs can capture the context and dependencies within code snippets, enabling more accurate and contextually relevant rewriting. This contextual understanding ensures that the rewritten code retains the original logic and functionality while adhering to the syntactic and semantic conventions of the higher version of the programming language.

Further, LLMs can be fine-tuned on domain-specific code corpora to improve their performance and accuracy in code rewriting tasks. Code corpora may be datasets digital language resources, either annotated or unannotated. By exposing the model to examples of code written in the lower and higher versions of the programming language, fine-tuning allows LLMs to learn the specific patterns, idioms, and conventions associated with each version. Additionally, transfer learning techniques may enable LLMs to leverage knowledge learned from pre-trained language models to bootstrap the learning process and adapt quickly to new code rewriting tasks.

Mathematical metrics such as accuracy, precision, recall, and F1 score may be used to evaluate the performance of LLMs in code rewriting tasks. The F1 score, also known as the F-score or F-measure, may be a metric used to evaluate the performance of a machine learning model. These metrics can quantify the model's ability to accurately rewrite code while minimizing errors, inconsistencies, and deviations from the original functionality. Additionally, mathematical optimization techniques such as gradient descent and stochastic gradient descent may be used to train LLMs and fine-tune their parameters for improved performance and convergence.

By leveraging these mathematical principles and techniques, LLMs can automate the code rewriting process, accelerate software migration efforts, and ensure the consistency, accuracy, and maintainability of the rewritten code across different programming language versions.

The customization upgrade framework provided by system 100 may allow for the evaluation of existing customizations for compliance with the latest code standards and application constraints, and the automatic upgrade of the customizations to meet those standards and constraints by utilizing and LLM, as described herein. System 100 may include a user device or system 122, and a service product 120. Service product 120 may include a customization store 102, a customization administration service 104, a customization pre-processor service 106, a prompt generation service 108, an LLM 110, an upgraded customization 112, and a validation framework 114. Components of system 100 may communicate via one or more network connections, including wired or wireless, intranet or internet, and within private cloud environments or across public network channels. Components of system 100 may be implemented via one or more computing devices and software systems, including physical and virtual systems, such as physical servers and cloud computing pods.

The user device 122 may correspond to a customer or client of the service product 120. The user device 122 may be used to access and interact with service product 120, such as a B2C service platform hosted by a cloud service provider. Further, the user device 122 may be used to upload or create an initial customization program or file to use with the service product 120, and store a copy to customization store 102. A client may initiate or request an automatic upgrade of an existing customization via the user device 122.

Service product 120 may include a software application such as a SaaS or PaaS executing on computing resources, such as servers, workstations, computers, other computing devices, or cloud computing resources, managed or operated by a developer for the cloud-based software application or platform. In some embodiments, service product 120 may be hosted in a cloud environment running out of one or more facilities run by a cloud service provider. The service product 120 may be configured to provide auto-upgrade functionality for customizations uploaded to or connected to the service product 120, in addition to any other functionality the service product 120 provides. For example, the service product 120 may be a business to consumer (B2C) service product that also supports customization auto-upgrade functionality.

The customization store 102 may be a part of the service product 120 that persists or stores customizations. The customization store 102 can include one or more databases, file systems, etc, based on the type of the customization. Customizations may be stored or saved to the customization store 102, and from there loaded or executed to interact with and modify the service product 120.

The customization administration service 104 may be a module through which customer administrators can create or modify product customizations (e.g., via user device 122). The customization administration service 104 may perform background processing for retrieving or storing customizations to customization store 102, or creating, modifying, updating, deleting, or executing, or performing verification or checks on existing customizations. Further, the customization administration service 104 may provide an application programming interface (API) or user interface (UI) to enable user device 122 to access the functionality of the customization administration service 104. In the example embodiment of FIG. 1, in response to an auto-upgrade request from user device 122, the customization administration service 104 may fetch a current or existing customization, and provide it to a customization pre-processor service 106 for analysis, in addition to sending a copy of the existing customization to a prompt generation service 108.

The customization pre-processor service 106 may include a module configured to perform verification or other checks on customizations, to determine whether they comply with and execute properly on a specified programming language version and service product 120 version. For example, the customization pre-processor service 106 may be automatically configured to check customizations against a current version of the service product 120 and the latest version of a programming language supported by the service product 120, or a version of the service product 120 or programming language can be specified by a user or administrator. If the service product 120 supports multiple programming languages, the customization pre-processor service 106 may be configured to check compliance with all or any of the supported languages. The customization pre-processor service 106 may include two analyzer layers: a programming language semantic analyzer 116 for programming language versions; and a service constraint analyzer 118 for proprietary constraint analysis on the version of the programming language (e.g., constraints based on an architecture or design of the service product 120). In the example of FIG. 1, an existing customization received from customization administration service 104 may be run through each of the two analyzers.

The programming language semantics analyzer 116 can perform a syntax and semantics analysis of the existing customization against a latest version of the service product-supported version of the programming language in which the current customization is written or executed. For example, a customization made using custom scripts that run against PHP5.6 may be run against the latest supported version of PHP (8.x) to identify syntactical and semantical deprecations, errors, warnings. The semantic analyzer 116 may, for example, identify data structures, object types, or function names that are no longer supported, or determine code structures that result in a compiling error. The identified deprecations, errors, or warnings may be output as semantic changes to the prompt generation service 108.

A service product 120 may impose constraints and restrictions on any supported version of a programming language, for example to adhere to corporate security architecture requirements of the service product administrator. The service constraint analyzer 118 can evaluate the existing customizations against the constraints imposed by the service product 120 for the latest version of the supported programming language(s). For example, the service product 120 may execute a custom version of a PHP language that disables certain functions for security purposes, and the constraint analyzer 118 may identify any proprietary constraint-based issues in the existing customization. Any identified proprietary constraint issues may be provided as output to the prompt generation service 108.

The prompt generation service 108 may take three inputs, including the existing customization, and the two analyzer outputs. Based on the inputs, the prompt generation service 108 may be configured to create an LLM prompt designed to instruct an LLM 110 to perform the automatic customization rewrite to the latest version of the supported programming language. For example, the prompt generation service 108 may generate a structured or natural language prompt that directs the LLM 110 to take the provided existing customization and rewrite it to address the errors identified in the analyzer outputs.

The LLM model 110 may be trained to take the input prompt from the prompt generation service 108 and perform the customization rewrite. For example, the LLM 110 may be trained to write code in one or more supported programming languages (e.g., there may be a different LLM 110 for each supported language, or one LLM 110 that can write in all supported languages). The LLM 110 may be trained to recognize the error outputs from the semantic analyzer 116 and constraint analyzer 118, so that deprecated or unsupported data types or functions (e.g., from prior programming language versions) can be identified, located within the existing customization, and replaced with code that accomplishes the same functionality using the lasted supported programming language syntax. The output of the LLM 110 may be an upgraded customization file or script 112, which may be run through a validation framework 114.

The validation framework 114 may be used to validate the accuracy of the upgraded customization 112. Validation framework 114 may apply automated validation steps, manual steps, or a combination thereof. In an example embodiment, the generated upgraded customization 112 may be run through the customization pre-processor service 106, which may run the semantics analyzer 116 and the constraint analyzer 118 for the upgraded customization 112. For a successful upgrade, the expectation may be that the output from these analyzers should be empty. If the output is non-empty, the validation framework 114 run the new errors and existing customization through the LLM 110 again (e.g., for a selected number of cycles before giving up or being manually reviewed), or may report an error and prompt the customers to do a manual upgrade, or a combination thereof. If the upgraded customization 112 passes the validation operation, it may be stored to the customization store 102, and utilized with the service product 120 going forward.

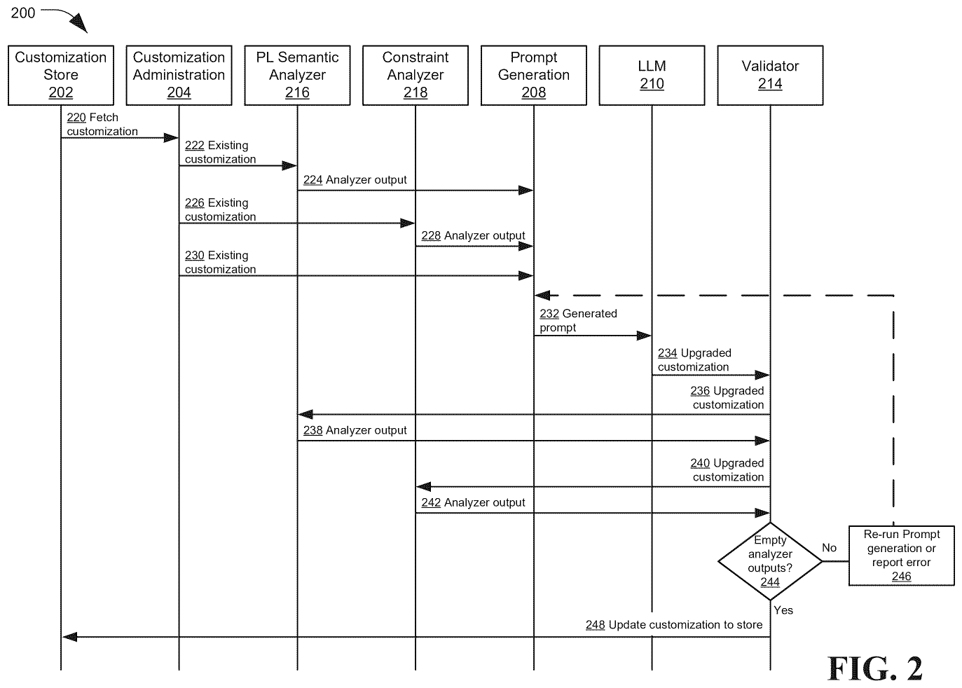

Utilizing the systems and methods proposed herein can provide substantial benefits in customizable software environments. The ease provided by automated upgrading of customizations may encourage customers to use the most up-to-date version of a software product or programming language, thereby implementing fixes and security upgrades that make computing systems more reliable and secure. Customer bases that upgrade to the latest service product 120 version may reduce the workload on the service product administrator in supporting older versions of the product. The solution may be used with a generic LLM 110, rather than requiring a custom-built or trained model. The computational costs of the LLM 110 may be limited by utilizing a pre-processing service 106 to identify problems and generate inputs for the prompt generation service 108. The constraint analyzer 118 may mean that no additional retraining of the LLM 110 may be required to support specific constraints of the service product 120. The prompt generation service 108 may create prompts containing the exact steps to be performed on the existing customization, resulting in reliable output from the LLM 110. A process flow for implementing auto-upgrades of cloud service customizations is discussed in regard to FIG. 2.

FIG. 2 is a flow diagram of an example system 200 for implementing auto-upgrade of cloud service customizations, in accordance with certain embodiments of the present disclosure. In particular, system 200 may include a customization store 202, a customization administration service 204, a programming language semantic analyzer (semantic analyzer) 216, a service constraint analyzer (constraint analyzer) 218, a prompt generation service 208, a large-language model (LLM) 210, and a validation framework (validator) 214. The components of system 200 may substantially correspond to the components service product 120 of FIG. 1.

At 220, the customization administration service 204 may fetch an existing customization from the customization store 202. The customization administration 204 may fetch the customization in response to a request or control from a client, administrator, or other user to upgrade the customization, or it may attempt to automatically upgrade customizations based on, e.g., an update to the service product software or supported versions of programming code languages.

The customization administration service 204 may provide the existing customization to a number of other components of system 200. At 222, it may provide the existing customization to a programming language (PL) semantic analyzer 216. The semantic analyzer 216 may evaluate the existing customization against a current programming language version to identify functions, variable types, libraries, or other components of the customization code that are not recognized or supported in the current programming language version. At 224, the result of the analysis may be provided as semantic analyzer output to a prompt generation service 208.

The customization administration service 204 may provide the existing customization to a constraint analyzer 218, at 226. The constraint analyzer 218 may evaluate the existing customization against any special or proprietary constraints or limitations on the current programming language version supported by the cloud service product. For example, certain functions, libraries, etc. supported by the current version of the programming language, and that would pass analysis by the semantic analyzer 216, may be flagged as unsupported by the constraint analyzer 218, due to security or other considerations for the cloud service architecture. At 228, the constraint analyzer output may be provided to the prompt generation service 208.

The customization administration service 204 may also provide the existing customization to the prompt generation service 208, at 230. Based on the semantic analyzer output 224, the constraint analyzer output 228, and the existing customization 230, the prompt generation service 208 may produce a prompt configured to direct an LLM 210 to produce a specific output. Namely, the prompt generation service 208 may generate a prompt that directs the LLM 210 to rewrite the existing customization in order to correct or update any errors identified in the analyzer outputs, while maintaining the existing functionality. The prompt generation service 208 may send the generated prompt to the LLM 210, at 232.

The LLM 210 may, based on the received prompt 232, parse through the existing customization to identify and rewrite portions that resulted in errors or warnings from the analyzer outputs. The rewritten code may be provided as an updated customization to a validator 214, at 234.

The validator 214 may perform one or more automated, manual, or hybrid validation operations on the updated customization. Validation may be performed because the LLM 210 may have failed to fix one or more issues identified by the analyzers in the existing customization, or may have corrected the existing issues while introducing new issues or problems. In an example embodiment, the validation may run the upgraded customization through the PL semantic analyzer 216 and the constraint analyzer 218. At 236, the validator 214 may provide the upgraded customization to the semantic analyzer 216, which may perform its programming language analysis and return its output to the validator, at 238. At 240, the validator 214 may provide the upgraded customization to the constraint analyzer 218, which may perform its proprietary constraint analysis and return its output to the validator, at 242.

At 244, the validator 214 may determine whether the analyzer outputs are empty (e.g., contain no errors). If there are still errors, the validator 214 may re-run the prompt generation, at 246, by submitting the analyzer outputs and the upgraded customization to the prompt generation service 208. The prompt generation service 208 may then produce a new prompt to submit to the LLM 210 to create a new upgraded customization. Alternately, or after a selected number of automated cycles to rewrite the customization, the validator may report an error that the automated upgrade of the customization has failed. The error notification may be submitted to a customer or client indicating that they will need to manually upgrade the existing customization. In another example, the error report may be provided to an administrator or other reviewer associated with the cloud service product, to evaluate upgraded customization, the analyzer outputs, or both, to attempt to identify or correct the remaining issues. Other validation or correction operations are also possible.

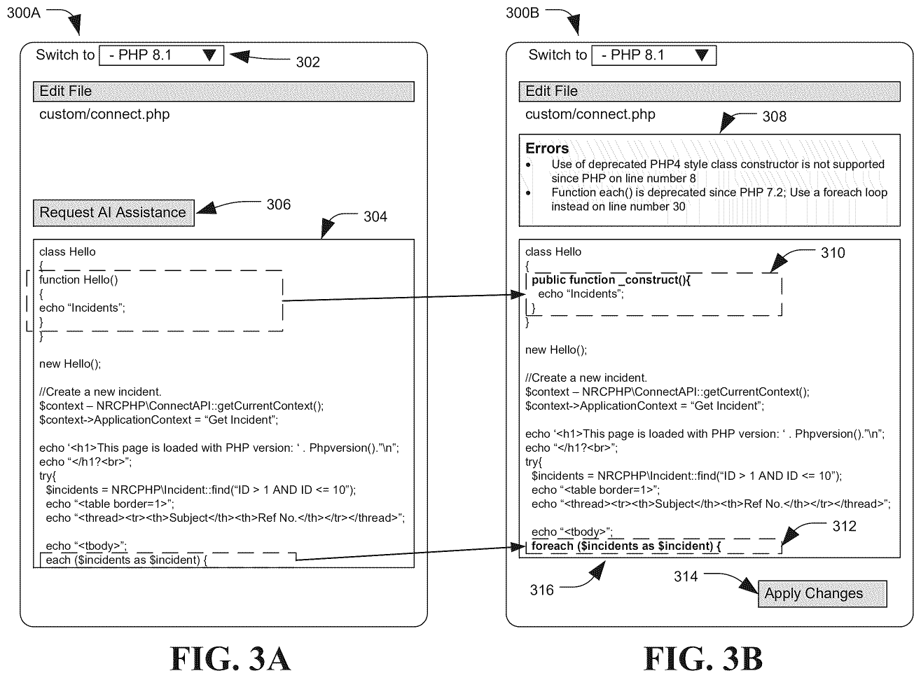

If the analyzer outputs are empty, at 244, the validator 214 may store the updated customization to the customization store 202, at 248. The updated customization may be stored over the existing customization, or may be stored as a new copy in addition to the existing customization. The validator 214 may store the updated customization automatically upon it clearing the validation process, or may only store the updated customization based on a user or client request. An example of a client or customer user interface for the auto-upgrade of cloud service customizations is discussed in regard to FIG. 3.

FIGS. 3A and 3B depict diagrams 300A and 300B of a user interface for a system configured to implement auto-upgrade of cloud storage customizations, in accordance with certain embodiments of the present disclosure. In particular, diagrams 300A and 300B may depict an example customer or administrator dashboard or web interface via which users may review existing customizations, and manually update them or request automated customization upgrade assistance. The diagrams 300A and 300B may include examples of a user interface (UI) for the service product 120 presented on a user device 122 of FIG. 1, and may interface with the service product 120 and its constituent components.

FIG. 3A may depict a diagram 300A of a UI to view or modify an existing customization for a cloud service product; in this case, a file stored as “custom/connect. php”, which may be stored to customization store 102 of FIG. 1. The code of the customization may be presented in window 304 of the UI. The existing customization may be written or coded in a prior version of the PHP programming language, such as PHP 5.6. Meanwhile, the customer may wish to update the customization to function with a newer version of the programming language, such as PHP 8.1. The UI may present a drop-down box 302 or other selector element that may enable the user to specify which version of the programming language to which they wish to update a customization; in the depicted example, the drop-down box 302 has been set to PHP 8.1.

As the existing customization may be written in an older version of PHP, there may be various code segments, function calls, data types, or other elements that are no longer supported in PHP 8.1, or that are not supported by a current version of the cloud service product due to special constraints. A user may manually edit the customization, by researching what coding syntax has changed between PHP 5.6 and 8.1, determining special constraints of the cloud service product, and then going through the customization carefully to change any necessary elements and hope that nothing was missed. However, this may be time-consuming, error-prone, and complicated. Alternately, the UI may provide a button 306 or other functionality directing the cloud service product to apply AI or other automatically rewrite the customization in order to bring it into compliance with the selected code version 302 and the current service product version. Clicking on the “Request AI assistance” button 306 may cause the service product to execute the auto-upgrade of cloud service customizations systems and processes discussed herein to rewrite the current customization, which may update the UI to the diagram 300B of FIG. 3B.

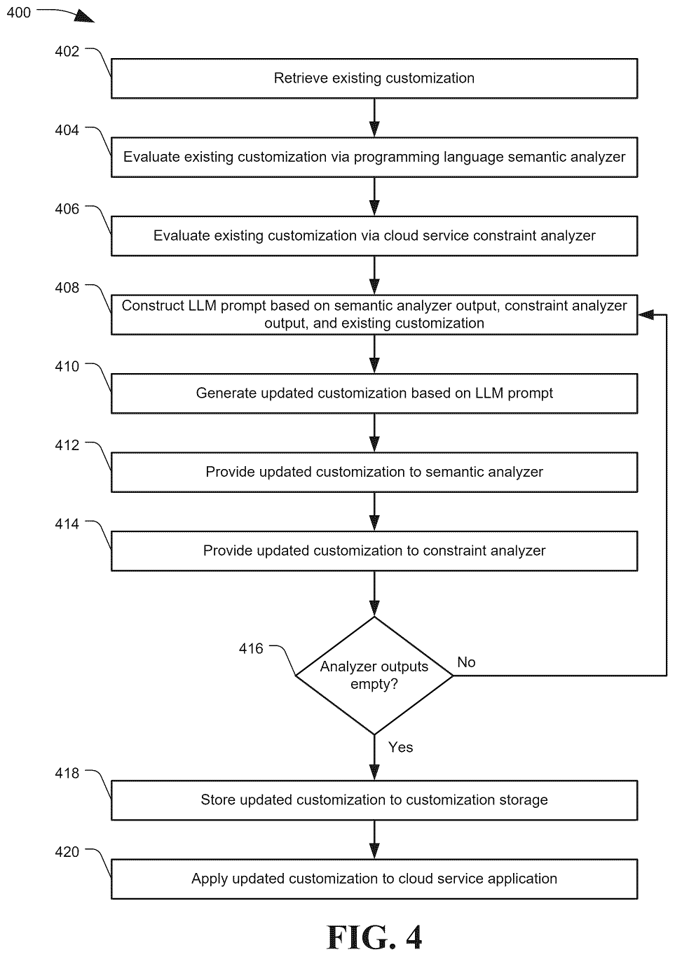

FIG. 3B may depict a diagram 300B of the UI for viewing or modifying a customization after the auto-upgrade or rewrite functionality has been executed. The existing customization from window 304 may have been run through one or more analyzers, such as a programming language semantic analyzer 116 and a service constraint analyzer 118 of FIG. 1, which may have output one or more error messages displayed in an error box 308. The errors 308 may indicate that the existing customization includes unsupported features, such as “Use of deprecated PHP4 style class constructor is not supported since PHP on line number 8”, and “Function each( ) is deprecated since PHP 7.2; Use a foreach loop instead on line number 30”. Based on these errors, an LLM may have rewritten the existing customization to the version depicted in box 316. As shown, the cloud service application may have corrected the errors 308 to bring the updated customization 316 into compliance with the current version of the cloud service application and programming language version 302. For example, at 310 the class constructor style for class “Hello” has been updated, and at 312 the “each” loop has been replaced with a “foreach” loop. The UI for diagram 300B may also include an “Apply changes” button 314, or other functionality directing the cloud service product to save the updated customization (e.g., to customization store 102), and to make the updated customization active with the cloud service product. An example method of implementing automatic customization upgrades is described in regard to FIG. 4.

FIG. 4 is a flowchart 400 of a method for auto-upgrade of cloud storage customizations, in accordance with certain embodiments of the present disclosure. In particular, the method may depict an example method to automatically evaluate an existing customization for compliance with a selected programming language version and cloud service product version, and to automatically rewrite the customization to bring it into compliance. The method of flowchart 400 may be executed by components of a cloud service product, such as service product 120 and it constituent components as described in regard to FIG. 1.

The method may include retrieving an existing customization, at 402, such as from a customization store or from a client device. The existing customization may be retrieved for evaluation automatically (e.g., in response to the upgrade of the service product software to which the customization applies, or to a related supported programming language version), or may be retrieved in response to a manual request or command.

At 404, the method may include evaluating the existing customization via a programming language semantic analyzer, to determine any elements of the existing element code that do not comply with the selected version of the programming language. Additionally, the method may include evaluating the existing customization via a cloud service constraint analyzer, to determine whether the existing customization includes any code that does not comply with any special or proprietary constraints imposed by the cloud service beyond the requirements of the supported programming language version.

At 408, the method may include constructing a large-language model (LLM) prompt based on the semantic analyzer output, the constraint analyzer output, and the existing customization. The prompt may make explicit that the target LLM is to rewrite the existing customization based on the selected programming language version and cloud service product version, in order to address any errors identified by the analyzers. Accordingly, at 410 the method may include generating an updated customization based on the LLM prompt, for example using a generic or specially-trained LLM AI model.

The updated customization may be provided from the LLM to the semantic analyzer, at 412, and to the constraint analyzer, at 414. The analyzers may evaluate the updated customization to determine whether it includes any code that does not meet the standards or requirements of the selected programming language version or cloud service product version.

At 416, an evaluation may be made whether the analyzer outputs are empty (e.g., whether any errors, warnings, or other problems were detected). If the outputs are not empty, the method may include submitting the analyzer outputs and the updated customization to the LLM in order to rewrite the updated customization to address any errors, at 408. Alternately, or after a number of rewrite iterations, an error message or notification may be generated that the customization requires human evaluation, or that the existing customization should be manually updated.

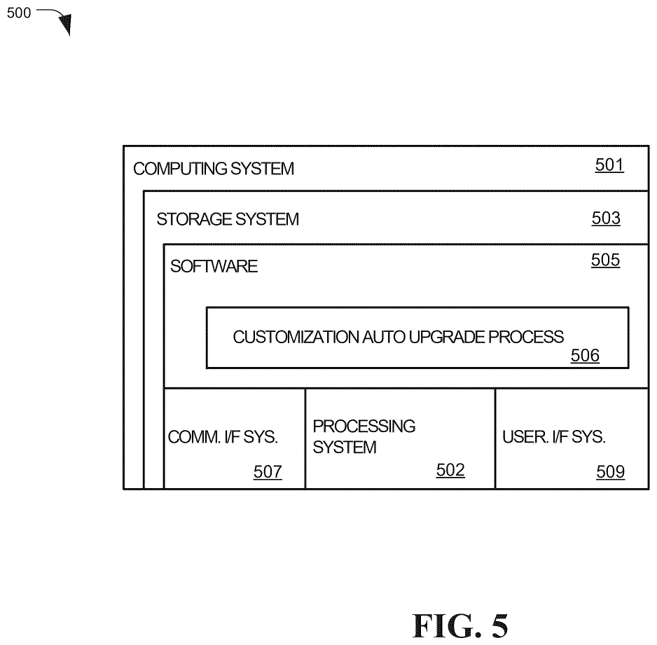

If the analyzer outputs are empty, at 416, the method may include storing the updated customization to customization storage, at 418. The customization store or storage may be part of the cloud service product, or may be otherwise situated, such as a client or customer device. At 420, the method may include applying the updated customization to the cloud service application. The updated customization may effectively integrate with and correctly function with the latest or selected version of the cloud service application, whereas the previous “existing” customization may have not functioned correctly. A computing system configured to perform the operations and methods described herein is provided in regard to FIG. 5.

FIG. 5 illustrates an apparatus 500 including a computing system 501 that is representative of any system or collection of systems in which the various processes, systems, programs, services, and scenarios disclosed herein may be implemented. For example, computing system 501 may be an example of service product 120, customization store 102, customization administration service 104, customization pre-processor service 106, programming language semantic analyzer 116, service constraint analyzer 118, prompt generation service 108, LLM 110, validation framework 114, or user device 122 of FIG. 1. Examples of computing system 501 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement customization auto upgrade process 506, which may be representative of any of the operations for evaluating an existing customization for compliance with a current or selected version of a cloud service application, programming language, or both, and automatically rewriting the customization code to bring the customization into compliance, as discussed with respect to the preceding figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including customization auto upgrade process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to implement a bundled binding audit process as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for” but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A customization upgrade system, comprising:
one or more processors; and
a memory having stored thereon instructions that, upon execution by the one or more processors, cause the one or more processors to implement a software customization upgrade process to automatically rewrite an existing customization to meet selected programming language requirements, a customization being custom programming code designed to alter a functionality of a software product, the software customization upgrade process including:
retrieve an existing customization written in a first version of a programming language supported by the software product;
evaluate the existing customization using a first analyzer to identify compatibility errors between the existing customization and a selected version of the programming language supported by the software product;
generate a large-language model (LLM) prompt based on the compatibility errors and the existing customization; and
write an updated customization compatible with the selected version of the programming language using an LLM based on the LLM prompt.

2. The customization upgrade system of claim 1, wherein:
the first analyzer is a programming language semantic analyzer configured to recognize programming code not supported by the selected version of the programming language; and
the first analyzer generates a semantic analyzer output identifying the compatibility errors based on the programming code not supported by the selected version of the programming language identified in the existing customization.

3. The customization upgrade system of claim 2, further comprising instructions that, upon execution, cause the one or more processors to:
evaluate the existing customization using a second analyzer comprising a service constraint analyzer configured to identify elements of the existing customization that violate proprietary constraints on the selected version of the programming language imposed by the software product; and
generate constraint analyzer output identifying the elements of the existing customization that violate the proprietary constraints.

4. The customization upgrade system of claim 3, further comprising instructions that, upon execution, cause the one or more processors to:
generate the LLM prompt based on the semantic analyzer output, the constraint analyzer output, and the existing customization.

5. The customization upgrade system of claim 4, further comprising instructions that, upon execution, cause the one or more processors to:
evaluate the updated customization for compatibility with the selected version of the programming language supported by the software product.

6. The customization upgrade system of claim 5, further comprising instructions that, upon execution, cause the one or more processors to:
evaluate the updated customization for compatibility, further including evaluating the updated customization via the programming language semantic analyzer; and
output a second semantic analyzer output based on evaluating the updated customization.

7. The customization upgrade system of claim 6, further comprising instructions that, upon execution, cause the one or more processors to:
evaluate the updated customization for compatibility, further including evaluating the updated customization via the service constraint analyzer; and
output a second constraint analyzer output based on evaluating the updated customization.

8. The customization upgrade system of claim 7, further comprising instructions that, upon execution, cause the one or more processors to:
determine whether the second semantic analyzer output or the second constraint analyzer output indicate an error with the updated customization;
when the error with the updated customization is indicated:
generate a second LLM prompt based on the second semantic analyzer output, the second constraint analyzer output, and the updated customization; and
rewrite the updated customization using the LLM based on the second LLM prompt.

9. The customization upgrade system of claim 8, further comprising instructions that, upon execution, cause the one or more processors to:
when the error with the updated customization is not indicated, apply the updated customization to the software product.

10. The customization upgrade system of claim 1, wherein:
the software product is a cloud service application;
the first version of the programming language is a previous version supported by an earlier version of the software product; and
the software customization upgrade process converts the existing customization into the updated customization written in a latest version of the programming language supported by a current version of the software product, the updated customization having the same functionality as the existing customization.

11. A method comprising:
operating a customization upgrade system to implement a software customization upgrade process to automatically rewrite an existing customization to meet selected programming language requirements, a customization being custom programming code designed to alter a functionality of a software product, the software customization upgrade process including:
retrieving an existing customization written in a first version of a programming language supported by the software product;
evaluating the existing customization using a first analyzer to identify compatibility errors between the existing customization and a selected version of the programming language supported by the software product;
generating a large-language model (LLM) prompt based on the compatibility errors and the existing customization; and
writing an updated customization compatible with the selected version of the programming language using an LLM based on the LLM prompt.

12. The method of claim 11, further comprising:
the first analyzer is a programming language semantic analyzer configured to recognize programming code not supported by the selected version of the programming language; and
generating, via the first analyzer, a semantic analyzer output identifying the compatibility errors based on the programming code not supported by the selected version of the programming language identified in the existing customization.

13. The method of claim 12, further comprising:
evaluating the updated customization for compatibility with the selected version of the programming language supported by the software product.

14. The method of claim 13, further comprising:
evaluating the updated customization for compatibility, further including evaluating the updated customization via the programming language semantic analyzer; and
outputting a second semantic analyzer output based on evaluating the updated customization.

15. The method of claim 14, further comprising:
evaluating the existing customization using a second analyzer comprising a service constraint analyzer configured to identify elements of the existing customization that violate proprietary constraints on the selected version of the programming language imposed by the software product; and
generating constraint analyzer output identifying the elements of the existing customization that violate the proprietary constraints.

16. The method of claim 15, further comprising:
generating the LLM prompt based on the semantic analyzer output, the constraint analyzer output, and the existing customization.

17. The method of claim 16, further comprising:
evaluating the updated customization for compatibility, further including evaluating the updated customization via the service constraint analyzer; and
outputting a second constraint analyzer output based on evaluating the updated customization.

18. The method of claim 17, further comprising:
determining whether the second semantic analyzer output or the second constraint analyzer output indicate an error with the updated customization;
when the error with the updated customization is indicated:
generating a second LLM prompt based on the second semantic analyzer output, the second constraint analyzer output, and the updated customization; and
rewriting the updated customization using the LLM based on the second LLM prompt.

19. The method of claim 18, further comprising:
applying the updated customization to the software product when the error with the updated customization is not indicated.

20. The method of claim 11, wherein:
the software product is a cloud service application;
the first version of the programming language is a previous version supported by an earlier version of the software product; and
the software customization upgrade process includes converting the existing customization into the updated customization written in a latest version of the programming language supported by a current version of the software product, the updated customization having the same functionality as the existing customization.
